(19) United States
(12) Patent Application Publication
(10) Pub. No.: US 2004/0218552 A1
(43) Pub. Date: Nov. 4, 2004

(54) Service system for arranging conversations between people without disclosing their identities, and a telecommunication system provided therewith

(76) Inventor: Leonid Polyakov, Dix Hills, NY (US)

Correspondence Address: Ilya Zborovsky, 6 Schoolhouse Way, Dix Hills, NY, 11746, US

(21) Appl. No.: 10/418,580

(22) Filed: Apr. 19, 2003

(51) Int. Cl. H04Q 11/00

(52) U.S. Cl. 370/260

(57) ABSTRACT

In a telecommunication system, in addition to regular telecommunications between communication devices customers in which they disclose their identities to one another, any customer can automatically introduce a greeting without disclosing his/her identity and hear greetings of other customers without disclosing their identities in order to make contacts therebetween, to arrange meetings, to schedule dating, etc., and also subsequently a live voice conversation between the customers, an exchange of still images between the customers, and an exchange of moving images between the customers is provided as well.

### BACKGROUND OF THE INVENTION

The present invention relates to a service system for arranging conversations between people without disclosing their identities, and a telecommunication system provided therewith.

The service systems for arranging conversations between people without disclosing initially their identities, such as for example dating services, as well as telecommunication systems provided therewith are known in the art. It is believed that such systems can be further improved.

### SUMMARY OF THE INVENTION

Accordingly, it is an object of the present invention to provide a service system for arranging conversations between people without disclosing their identities, and a telecommunication system provided therewith, which are further improvements of the existing systems.

In keeping with these objects and with others which will become apparent hereinafter, one feature of the present invention resides, briefly stated, in a telephone service system for arranging conversations between people without disclosing their identities, comprising a telecommunication service provider; a plurality of communicating devices usable by customers; automatic teleconversation arranging means for arranging teleconversations between the customers of the communicating devices without disclosing their identities, said automatic teleconversation arranging means including greeting introducing means operative for introducing a voice and/or image greeting from a customer of one of the communicating devices without disclosing his or her identity, and greeting broadcasting means operative for broadcasting other voice and/or image greetings of other customers without disclosing their identities within a time when said one customer is connected with said automatic teleconversation arranging means so as to allow said one customer to hear and/or see greetings which have been introduced by said other customers of said telecommunication devices; means for subsequently arranging a live voice conversation between said one customer and at least one of said other customers; and means for subsequently transmitting images between said one customer and at least one of said other customers.

In accordance with another feature of the present invention, a telecommunication system is provided which has a telecommunication service provider; a plurality of communication devices usable by a plurality of customers of said service provider so that a customer can use his or her communication device to call other customers having communication devices for having an open conversation without identifying himself or herself; automatic teleconversation arranging means for arranging teleconversations between the customers of the communication devices without disclosing their identities, said automatic teleconversation arranging means including greeting introducing means operative for introducing a voice and/or image greeting from a customer of one of the communication devices without disclosing his or her identity, and greeting broadcasting means operative for broadcasting other voice and/or image greetings of other customers without disclosing their identities within a time when said one customer is connected with said automatic teleconversation arranging means so as to allow said one customer to hear and/or see greetings which have been introduced by said other customers of said communication devices; means for subsequently arranging a live voice conversation between said one customer and at least one of said other customers; and means for subsequently transmitting images between said one customer and at least one of said other customers.

When the service system for arranging teleconversations between people and a telecommunication system provided therewith are designed in accordance with the present invention, they constitute further improvements of the existing systems of this type.

### BRIEF DESCRIPTION OF THE DRAWINGS

FIG. 1 is a view schematically showing a telecommunication system which is provided with a service system for arranging teleconversation between peoples without disclosing their identities, in accordance with the present invention;

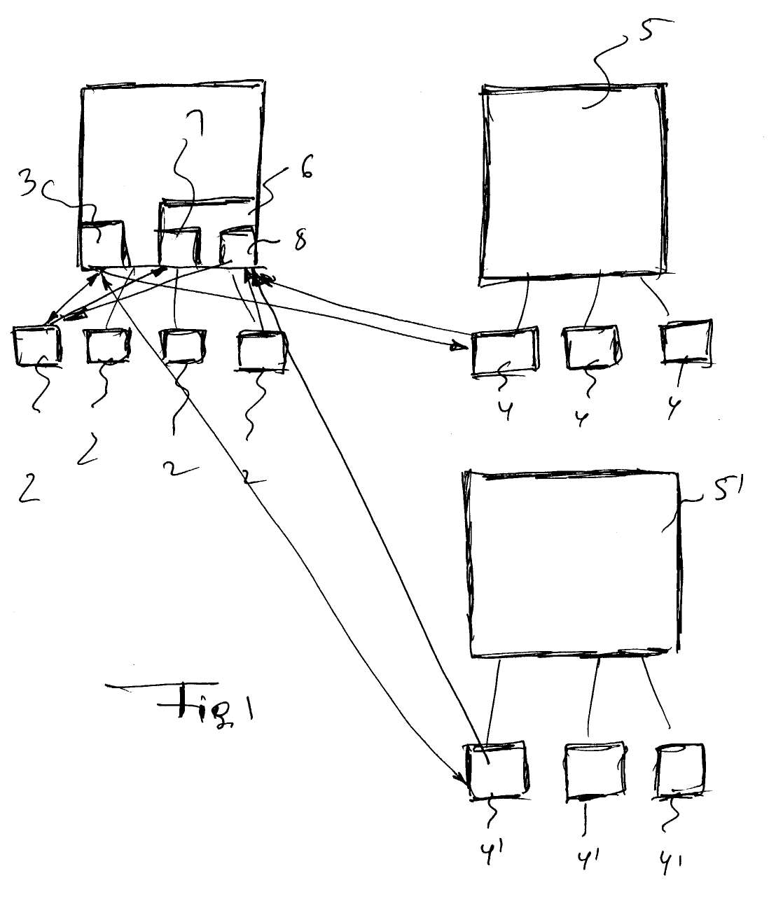

FIG. 2 is a view showing a part of the service system in accordance with the present invention in greater detail and on enlarged scale.

### DESCRIPTION OF THE PREFERRED EMBODIMENTS

A telecommunication system in accordance with the present invention which operates in accordance with the inventive method has a primary telecommunication service provider which is identified with reference numeral 1. The primary telecommunication service provider can be formed in any conventional way. The telecommunication system further includes a plurality of primary communication devices which are identified with reference numeral 2 and connected (wireless or with wires) to the primary telecommunication service provider 1. It receives for example payments from the users of the primary communication devices 2. The primary telecommunication service provider 1 has means 3 for connecting any customer who has a primary communication device 2 to other primary communication devices 2 of the same primary telecommunication service provider 1, and also to other communication devices 4, 4″ which are communication devices associated with other telecommunication service providers 5, 5′, etc.

The operation of this part of the illustrated telecommunication system is well known. When a customer who has a communication device 2 communicates with other people, the customer of the communicating device 2 dials a corresponding telephone number of either another communication device 2 of the same primary telecommunication service provider 1, or of a communication device 4, 4′, etc of the other telecommunication service providers 5, 5′, etc., and the primary telecommunication service provider 1 connects him correspondingly to have a conventional voice conversation.

In accordance with the present invention the telecommunication system is provided with automatic means allowing arrangement of teleconversations of customers of the system without disclosing their identities, for example for the purpose of dating between them, etc. The automatic teleconversation arranging means is identified as a whole with reference numeral 6 and is associated, for example, with the primary telecommunication service provider 1. The automatic teleconversation arranging means 6 includes first of all introducing means 7 which is operative for introducing a voice and/or image greeting provided by a customer of a communication device 2 without disclosing his or her identity. For example, the customer of the primary communication device 2 of the primary telecommunication service provider 1 presents himself or herself in his or her greeting by voice and/or image and describes his or her personality, lists his or her preferences for a person he or she wants to meet and to date, but without disclosing his or her identity.

The automatic teleconversation arranging means 6 also includes greeting broadcasting means which is identified with reference numeral 8. The greeting broadcasting means 8 is formed so that it broadcasts all greetings introduced by other customers of the primary communication device 2 of the same primary telecommunication service provider 1 during the time the above mentioned customer of the primary communication device 2 is connected with the automatic teleconversation arranging means 6, and the other customers also do not disclose their identities. When the customer of the primary communication device 2 sends his greetings by voice and/or image through the greeting introducing means 7 and connection with the automatic conversation arranging means 6, the customer also automatically hears and/or sees all other greetings from other customers of the primary communication devices 2 which are broadcasting by the greeting broadcasting means 8. If the customer finds any of the greetings of the other customers of the primary communication devices 2 interesting, the customer can initiate a conversation with such a person, for example by pressing a special button on his or her primary communication device, which sends automatically a signal to the primary telecommunication service provider 1 for subsequently arranging a personal teleconference.

It is therefore believed to be clear that in the telecommunication system which has been conventionally used only for providing a connection from one communication device customer to other communication device customers for regular conversations in which they speak with one another, disclose their identities, etc., additional means is provided and additional operation is possible which resides in introducing a greeting message by a customer of a communication device without disclosing his or her identity and listening and/or seeing by the customer other greeting messages from other customers of the communication devices which also do not disclose their identities, with a possibility of arranging a subsequent teleconversation between them.

In accordance with a further feature of the present invention, a customer of another communication device 4, 4′, etc., which is not a customer of the primary telecommunication service provider 1, but instead is a customer of the telecommunication service providers 5, 5′, etc., can also participate in the inventive telecommunication system, in particular can also participate in the interaction with the automatic teleconversation arranging means 6. Such additional customers of the other communication devices 4, 4′, etc., can use the automatic teleconversation arranging means 6 through which the other customers can introduce their greetings into the automatic teleconversation arranging means 6 without disclosing their identities and listen to and/or see the greetings from other customers. The automatic teleconversation arranging means 6 can be accessed by the other customers of the communication devices 4,4′, etc. In order to get access to the primary telecommunication service provider 1 by such other customers, they have to provide a payment, for example by a credit card, a telephone pay card, etc., or it can be done for free.

In the inventive telecommunication system the greetings therefore can be introduced by a customer of one of the communication devices 2, 4, 4′, etc., without disclosing his or her identity, can be listened to by a customer of other communication devices 2, 4, 4′, etc., also without disclosing the identity, and conversations can be arranged and carried out between the customers of the communication devices 2 and 2, 2 and 4, 2 and 4′, 4 and 4′, etc.

It should be mentioned that some or all communication devices 2, 4, 4′, etc., can be cellular telephones, wire based telephones, and other devices.

It is believed to be clear that in accordance with the present invention a service system for arranging conversations between the people, for example for the purpose of dating is provided, as well as a telecommunication system which incorporates such a system, and in the service system for arranging teleconversations the process is carried out without disclosing identities of the participants.

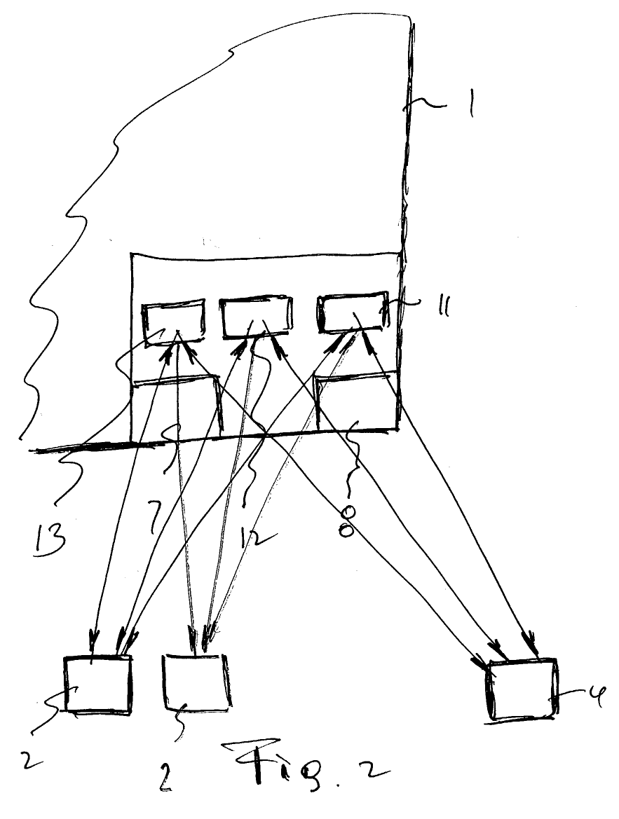

Important inventive features of the present invention are further illustrated on FIG. 2, which on an enlarged scale shows an automatic teleconversation arranging means 6 in accordance with the present invention.

The automatic teleconversation arranging means 6 include additional means 11 which provide a subsequent live voice conversation between the participants of the system. For example, after hearing and/or seeing by the customer of the communication device 2 the greeting of the customer of the communication device 4, such that the customer of the communication device 2 becomes interested in the customer of the communication device 4, the live voice conversation means 11 can be activated, so that with the live voice conversation means the customer of the communication device 2 and the customer of the communication device 4 can hold a live voice conversation between them, to ask questions, to become more acquainted with one another over the communication devices, to schedule meetings, dates, etc. This considerably enhances the attractiveness and efficiency of the system in accordance with the present invention.

The automatic teleconversation arranging means 6 further include still image displaying and transmitting means identified with reference numeral 12. If the customer of the communication device 2 listens to and/or sees the greetings from the customer of the communication device 4 and becomes interested in the customer of the communication device 4, he or she can subsequently initiate the operation of the still images displaying and transmitting means 12, so that the corresponding still images are transmitted from the customer of the communication device 4 to the customer of the communication device 2 and/or vice versa. Such still images can include photographs of the customer 4 and/or 2, so that the customers of the communication devices 2 and 4 visualize each other, or other still images can be transmitted as well to obtain more information about each other, about each other's features, life conditions, characteristics, etc. This additionally enhances the attractiveness and the efficiency of the inventive system.

The automatic teleconversation arranging means 6 further includes moving images displaying and transmitting means identified with reference numeral 13. When the customer of the communication device 2 listened to and/or sees the greeting to the customer of the communication device 4 and became interested in the customer of the communication device 4, he or she can activate the moving images displaying and transmitting means 13, so that the customer of the communication device 2 can see moving images such as a video, a movie, etc., related to the customer of the communication device 4 and vice versa. Therefore, the customer of the communication devices 2 obtains more information about the customer of the communication devices 4 and vice versa in form of the moving images related to the corresponding customer, his or her way of life, features, etc. This also further increases the attractiveness and efficiency of the inventive system.

It is to be understood that the means 11, 12 and 13 can be activated individually or jointly so as to provide subsequently any combination of the communications between the customer of the communication device 2 and the customer of the communication device 4, selected from the group consisting of live voice conversation, still images transmission, and the moving images transmission.

In order to conduct a live voice conversation between the customers, to obtain or exchange still images between the customers and to obtain or exchange moving images between the customers, additional means associated with the communication devices can be provided for enhancement of the corresponding communication processes. For conducting a live conversation, for obtaining or exchanging still images, for obtaining and exchanging moving images between the customers of the communication devices, the communication devices can be connected with speakers, radio sets, television sets, movie displaying sets, home entertaining systems, etc. The system or the communication device can be provided additionally with photo or video cameras, or a communication device can be provided which is operative for transmitting and receiving simultaneously or consequentially live voice, still images, and moving images.

It will be understood that each of the elements described above, or two or more together, may also find a useful application in other types of constructions differing from the types described above.

While the invention has been illustrated and described as embodied in service system for arranging teleconversations between people without disclosing their identities, and a telecommunication system provided therewith, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A service system for arranging teleconversations between people without disclosing their identities, comprising a telecommunication service provider; a plurality of communication devices usable by customers; automatic teleconversation arranging means for arranging teleconversations between the customers of the communication devices without disclosing their identities, said automatic teleconversation arranging means including greeting introducing means operative for introducing a voice and/or image greeting from a customer of one of the communication devices without disclosing his or her identity, and greeting broadcasting means operative for broadcasting other voice and/or image greetings of other customers without disclosing their identities within a time when said one customer is connected with said automatic teleconversation arranging means so as to allow said one customer to hear and/or see greetings which have been introduced by said other customers of said communication devices; means for subsequently arranging a live voice conversation between said one customer and at least one of said other customers; and means for subsequently transmitting images between said one customer and at least one of said other customers.

2. A system as defined in claim 1, wherein said images transmitting means include means for transmission of still images between said one customer and at least one of said other customers.

3. A system as defined in claim 1, wherein said images transmitting means includes means for transmitting moving images between said one customer and at least one of said other customers.

4. A system as defined in claim 1, wherein said images transmitting means include means for transmitting still images between said one customer and at least one of said other customers, and means for transmitting moving images between said one customer and at least one of said other customers.

5. A telecommunication system, comprising a telecommunication service provider; a plurality of communication devices usable by a plurality of customers of said service provider so that a customer can use his communication device to call other customers having a communication device for having an open teleconversation without identifying himself or herself; automatic teleconversation arranging means for arranging teleconversations between the customers of the communication devices without disclosing their identities, said automatic conversation arranging means including greeting introducing means operative for introducing a voice and/or image greeting from a customer of one of the communication devices without disclosing his or her identity, and greeting broadcasting means operative for broadcasting other voice and/or image greetings of other customers of the communication devices without disclosing their identities within a time when said one customer is connected with said automatic teleconversation arranging means so as to allow said one customer to hear and/or see greetings which have been introduced by said other customers of said communication devices; means for subsequently arranging a live voice conversation between said one customer and at least one of said other customers; and means for subsequently transmitting images between said one customer and at least one of said other customers.

6. A telecommunication system as defined in claim 5, wherein images said transmitting means include means for transmission of still images between said one customer and at least one of said other customers.

7. A telecommunication system as defined in claim 5, wherein said images transmitting means includes means for transmitting moving images between said one customer and at least one of said other customers.

8. A telecommunication system as defined in claim 5, wherein said images transmitting means include means for transmitting still images between said one customer and at least one of said other customers, and means for transmitting moving images between said one customer and at least one of said other customers.
